(19) United States
(12) Patent Application Publication
(10) Pub. No.: US 2022/0377571 A1
(43) Pub. Date: Nov. 24, 2022

(54) METHODS AND SYSTEMS FOR WIRELESS SIGNAL REINFORCEMENT AND WIRELESS NETWORK LOAD SHARING AND FOLLOWING

(71) Applicant: VICORETEK (NANJING) CO., LTD., Nanjing, Jiangsu (CN)

(72) Inventor: Ti-Wen YUAN, Nanjing, Jiangsu (CN)

(21) Appl. No.: 17/629,711

(22) PCT Filed: Jun. 10, 2020
(86) PCT No.: PCT/CN2020/095468

§ 371 Date: Jan. 24, 2022

(30) Foreign Application Priority Data
Jul. 25, 2019 (CN) 2019 10677662.5

(51) Int. Cl. H04W 16/18; H04W 64/00; H04W 28/02

(52) U.S. Cl. CPC H04W 16/18; H04W 64/003; H04W 28/0231; H04W 84/12

(57) ABSTRACT

The present publication relates to the wireless signal technologies, and provides methods and systems for wireless signal reinforcement and wireless network load sharing and following. The method for wireless signal reinforcement comprising: a mobile wireless access point moving and measuring the wireless signal strength of other wireless access points received at the location the mobile wireless access point passes through; determining a first location where the wireless signal needs to be reinforced according to the measurement result; and the mobile wireless access point moving to a second location according to the first location, so that the strength of the wireless signal transmitted by the mobile wireless access point from the second location to the first location exceeding the strength of the wireless signal of other wireless access points at the first location. The implementation of the publication can adaptively change the distribution of the environment wireless signals as the environment changes, and realize efficient coverage of wireless signals at low cost.

### TECHNICAL FIELD

The publication relates to wireless signal technology, in particular to wireless signal reinforcement and wireless network load sharing technology.

### BACKGROUND

According to different networking technologies, WiFi access points may be roughly divided into the access points of mobile communication technology (such as 2G, 3G, 4G, 5G, etc.) and broadband communication technology (such as xDSL, cable, FTTH, PON, etc.). No matter what kind of WiFi access point is used indoors or outdoors, it cannot achieve efficient coverage. At present, although mesh networking technology is available, multiple WiFi access points may be installed to expand coverage. However, in addition to the high cost of installing a large number of WiFi access points, this method also has many other problems.

### SUMMARY OF THE INVENTION

The publication provides a method and system for wireless signal reinforcement and wireless network load sharing and following, which can adaptively change the wireless signal distribution of the environment with the change of the environment, and realize the efficient coverage of wireless signals at low cost.

The publication discloses a wireless signal reinforcement method, comprising:

Measuring, by a mobile wireless access point, the wireless signal strength of other wireless access points while the mobile wireless access point moving;

Determining a first location where the wireless signal needs to be reinforced according to the measurement result; and

The mobile wireless access point moving to the second location according to the first location, so that the strength of the wireless signal transmitted by the mobile wireless access point from the second location to the first location exceeding the strength of the wireless signal of other wireless access points at the first location.

Optionally, before the mobile wireless access point moving to the second location according to the first location, the method further comprising:

Setting the access identifier of the mobile wireless access point as the access identifier of one of the other wireless access points that need to be reinforced.

Optionally, the other wireless access points are one or more specified wireless access points, or all wireless access points that can enable the wireless terminal to access the specified network.

Optionally, the mobile wireless access point moving along a pre-arranged route or moving randomly.

Optionally, before the mobile wireless access point moving, the method further comprising:

Determining whether the power of the mobile wireless access point meets the preset requirements;

The mobile wireless access point whose power does not meet the preset requirements moving to the charging pile for charging.

Optionally, the mobile wireless access point comprises a first wireless communication module and a second wireless communication module; wherein the first wireless communication module is configured to provide access services to wireless terminals, and the second wireless communication module is configured to access the mobile wireless access point to a specified communication network;

The first wireless communication module is a WiFi module, and the second wireless communication module is a mobile communication network module or a WiFi module.

The publication discloses a wireless signal reinforcement system, comprising a mobile wireless access point; and,

A measurement module configured to measure the wireless signal strength of other wireless access points while the mobile wireless access point moving;

A determination module configured to determine the first location where the wireless signal needs to be reinforced according to the measurement result;

A first control module configured to control the mobile wireless access point to move to the second location according to the first location, so that the strength of the wireless signal transmitted by the mobile wireless access point from the second location to the first location exceeding the strength of the wireless signal of the other wireless access points at the first location.

The publication discloses a wireless network load sharing method, comprising:

A mobile wireless access point moving and obtaining the access load information of other wireless access points that provide wireless access to the current location of the mobile wireless access point;

Determining a third location where the access load exceeds a preset threshold according to the obtained access load information; and

The mobile wireless access point moving to a fourth location according to the third location, so that the mobile wireless access point can provide additional access to the wireless terminal at the third location as load sharing.

Optionally, before controlling the mobile wireless access point to move to the fourth location according to the third location, it further comprises:

Setting the access identifier of the mobile wireless access point as the access identifier of one of the other wireless access points that provides other access to the wireless terminal at the third location.

Optionally, the other wireless access points are one or more specified wireless access points, or all wireless access points that enable the wireless terminal to access the specified network.

Optionally, the mobile wireless access point moving along a pre-arranged route or moving randomly.

Optionally, the mobile wireless access point comprises a first wireless communication module and a second wireless communication module; wherein the first wireless communication module is configured to provide access services to wireless terminals, and the second wireless communication module is configured to access the mobile wireless access point to a specified communication network;

The first wireless communication module is a WiFi module, and the second wireless communication module is a mobile communication network module or a WiFi module.

The publication discloses a wireless network load sharing system, comprising a mobile wireless access point; and,

A first acquisition module configured to acquire the access load information of other wireless access points that provide wireless access to the current location of the mobile wireless access point while the mobile wireless access point moving;

A load judgment module configured to determine a third location where the access load exceeds a preset threshold according to the obtained access load information;

A second control module configured to control the mobile wireless access point to move to the fourth location according to the third location, so that the mobile wireless access point can provide additional access to the wireless terminal at the third location as load sharing.

The publication discloses a wireless network load sharing method, comprising:

A network optimization module obtaining the access load information of the wireless access point;

and

Determining there is a wireless access point whose access load exceeds a preset threshold, obtaining the location of the wireless access point, and controlling one or more mobile wireless access points to move to a specified location according to the location of the wireless access point, so that the coverage areas of the one or more mobile wireless access points and the coverage area of the wireless access point at least partially overlap so as to share the access load of the wireless access point.

Optionally, the network optimization module is configured in an independent server connected with each wireless access point, or in one or more mobile wireless access points.

Optionally, before controlling one or more mobile wireless access points to move to a specified location according to the location of the wireless access point, the method further comprising:

Setting the access identifier of the one or more mobile wireless access points as the access identifier of the wireless access point that provides other access to the wireless terminal at the overlapped location.

Optionally, the wireless access point is one or more specified wireless access points, or all wireless access points that enable the wireless terminal to access the specified network.

Optionally, the wireless access point includes a fixed wireless access point and at least one mobile wireless access point;

The network optimization module is configured for obtaining the access load information of the wireless access point , determining there is a wireless access point whose access load exceeds a preset threshold, obtaining the location of the wireless access point, and controlling one or more mobile wireless access points to move to a specified location according to the location of the wireless access point, so that the coverage areas of the one or more mobile wireless access points and the coverage area of the wireless access point at least partially overlap so as to share the access load of the wireless access point.

The publication discloses a method for wireless network following service, where in comprising:

Obtaining the current location of a specified wireless terminal; and

The mobile wireless access point moving to a fifth location according to the current location, so that the mobile wireless access point can provide wireless access services to the specified wireless terminal.

Optionally, the priority of the specified wireless terminal is higher than a preset threshold.

Optionally, the method further comprising:

While the specified wireless terminal moving, the mobile wireless access point moving with the specified wireless terminal.

Optionally, the mobile wireless access point comprises a first wireless communication module and a second wireless communication module; wherein the first wireless communication module is configured to provide access services to wireless terminals, and the second wireless communication module is configured to access the mobile wireless access point to a specified communication network;

The first wireless communication module is a WiFi module, and the second wireless communication module is a mobile communication network module or a WiFi module.

The publication discloses a system for wireless network following service, comprising a mobile wireless access point; and,

A second acquisition module configured to acquire the current location of the specified wireless terminal;

A third control module configured to control the mobile wireless access point to move to the fifth location according to the current location, so that the mobile wireless access point can provide wireless access services to the specified wireless terminal at the current location.

The publication also discloses a device comprising:

A memory for storing computer executable instructions;

A processor for implementing the steps in the method described above when executing the computer executable instructions.

The publication also discloses a computer-readable storage medium in which computer executable instructions are stored. When the computer executable instructions are executed by the processor, the steps in the method described above are realized.

In the embodiment of the publication, a mobile wireless access point is moving, and the wireless signal strength of other wireless access points received is measured while the mobile wireless access point is moving, the best location of signal reinforcement is determined according to the measurement results, and the mobile wireless access point is controlled to move according to the best location to provide signal enhancement service for the location with weak wireless signal.

Optionally, the access identifier may be updated intelligently, making the accessed wireless terminal free of setup and seamless switch to the mobile wireless access point. On the one hand, the existence of wireless signal dead corners caused by, for example, obstruction by building compartments is avoided, on the other hand, the distribution of wireless signals in the environment may be changed adaptively with the change of the environment, and efficient coverage of wireless signals may be achieved at low cost.

In the process of location movement, the access load information of other wireless access points that provide wireless access to the passed location may be obtained, the location where the load exceeds the standard may be determined according to the obtained access load information, and the movement of the mobile wireless access point may be controlled according to the location to provide additional access for the location, so as to share the load. Further, the access identifier may be updated intelligently, making the accessed wireless terminal free of setup and seamless switch to the mobile wireless access point. The mobile wireless access point can dynamically and selectively distribute the overloaded fixed wireless access points according to the network load of the environment in real time, so as to effectively ensure the reasonable access of wireless terminals in the environment. Further, the wireless signal distribution of the environment may be adaptively changed as the environment changes. For example, the number of mobile wireless access points providing access to a location may be adaptively increased or reduced according to the increase and decrease of the number of wireless terminals at the location or the increase or decrease of the data flow of wireless terminals at the location. Thus, reasonable access of wireless terminals in this environment is effectively ensured, and efficient coverage of wireless signals is realized at low cost. The mobile wireless access point may be moved to the vicinity of a wireless terminal whose priority is higher than a preset threshold according to the current location, so that the mobile wireless access point can provide wireless access services to the wireless terminal at the current location. Further, the access identifier may be updated intelligently, making the accessed wireless terminal free of setup and seamless switch to the mobile wireless access point. Moreover, through setting or remote setting, the mobile wireless access point may become an intelligent follow-up wireless access point following a specific target, so as to provide mobile terminals or portable products with the lowest cost and the most efficient way to enjoy ubiquitous high-quality wireless access services.

The description of the present publication describes a large number of technical features which are distributed in various technical solutions. If all possible combinations of technical features (i.e. technical solutions) of the present publication were to be listed, the description would be too lengthy. To avoid this problem, technical features disclosed in the above summary of the invention of the present publication, technical features disclosed in the following embodiments and examples and technical features disclosed in the drawings may be combined with each other to constitute new technical solutions (these technical solutions are deemed to have been described in the description), unless the combination of technical features is not technically feasible. For example, the features

A+B+C are disclosed in one example, and features A+B+D+E is disclosed in another example., and features C and D are equivalent technical means serving the same purpose, and technically, only one of them may be used at the same time, and it is impossible to use both of them at the same time, and technically, feature e may be combined with feature C. Therefore, the scheme A+B+C+D should not be regarded as described because it is technically infeasible, and the scheme A+B+C+E should be regarded as described.

### BRIEF DESCRIPTION OF THE DRAWING

FIG. 1 is a flowchart of a wireless signal reinforcement method according to the first embodiment of the present publication

FIG. 2 is a structure diagram of wireless signal reinforcement system according to the second embodiment of the present publication

FIG. 3 is a flowchart of a wireless network load sharing method according to a third embodiment of the present publication

FIG. 4 is a structure diagram of a wireless network load sharing system according to the fourth embodiment of the present publication

FIG. 5 is a flowchart of a wireless network load sharing method according to a fifth embodiment of the present publication

FIG. 6 is a flow diagram of a method for wireless network following service according to a seventh embodiment of the present publication

FIG. 7 is a structure diagram of a system for wireless network following service according to an eighth embodiment of the present publication

FIG. 8 is a flowchart of a wireless network service process based on a mobile wireless access point according to example A of the ninth embodiment of the present publication

FIG. 9 is a flowchart of a wireless network service process based on a plurality of mobile wireless access points according to example B of the ninth embodiment of the present publication

FIG. 10 is a schematic diagram of state switching of example B

FIG. 11 is a structural diagram of a mobile wireless access point according to an embodiment of the present publication

FIG. 12 is a table in which the mobile wireless access point measures the signal strength information of other WiFi access points and integrates it with the locating and map information of Navigation and Location Unit according to an embodiment of the present publication

FIG. 13 is a network architecture diagram of a mobile wireless access point (with a network optimization module) according to an embodiment of the present publication

FIG. 14 is a network architecture diagram of a mobile wireless access point (without a network optimization module) and an independent network optimization module according to an embodiment of the present publication.

### DETAILED DESCRIPTION

In the following description, many technical details are set forth for a better understanding of the present publication by the reader. However, those skilled in the art can understand that the technical solution claimed in the publication may be realized even without these technical details and various changes and modifications based on the following embodiments.

Description of Some Concepts:

Server: refers to the computer system in the network that can provide services to other devices. The object of server service is usually called terminal or client. The server and terminal may be connected by wired or wireless communication. There are many ways to implement the server, which may be a single computer or a combination of multiple computer (such as cluster server, cloud server, etc.). In some publication scenarios, the server can also be called server, cloud, etc. Wireless access point: it is the access point of a wireless network, commonly known as “hot spot”. Generally, there are route switching access integrated equipment and pure access point equipment. The integrated equipment performs access and routing. The pure access equipment is only responsible for the access of wireless clients. The pure access equipment is usually used as a wireless network expansion and connected with other AP or main AP to expand the wireless coverage area. The typical access point is the wireless access point of WiFi. Of course, it can also be the wireless access point of wireless network.

SSID: service set identification. A WLAN may be divided into several sub networks requiring different authentication. Each sub network requires independent authentication. Only authenticated users will have access to the corresponding sub-networks to prevent unauthorized users from accessing the network.

In order to make the objectives, technical solutions and advantages of the publication clearer, the embodiment of the publication will be further described in detail below with reference to the drawings.

At present, there are various problems in the traditional wireless signal coverage. For example, in indoor or domestic environments, the signals of WiFi access points are often blocked by building compartments, especially in the 5GHz band. Or, in outdoor or shopping malls and other publications, in addition to the indoor or household coverage problem, it cannot effectively respond to the WiFi access point bandwidth access demand caused by the emergence of people in local places. Although the new WiFi standard 802.11v has the characteristics of WiFi network load balancing, on the one hand, it does not have the commercial support of most manufacturers, on the other hand, it still cannot meet the bandwidth access demand caused by the emergence of people in local places. With the popularity of smart mobile terminals or portable products (such as smart phones, smart watches, smart speakers, smart assistant echo, etc.), the demand for wireless networks is increasing. In addition to the charging mobile network, the signal coverage of traditional WiFi cannot meet the ubiquitous demand of WiFi now and in the future. It is a trend of future to provide high-quality WiFi services in time for mobile terminals or portable products.

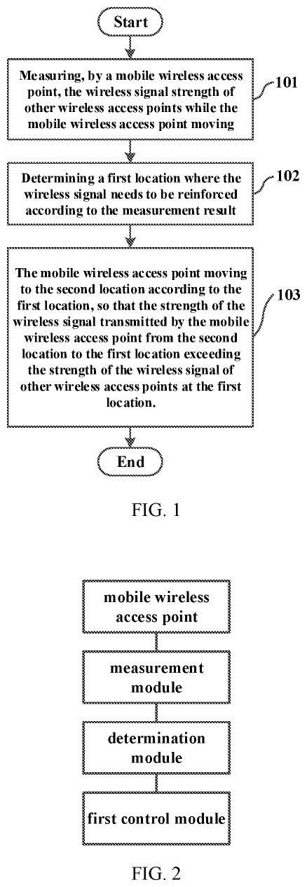

In view of the above situation, the first embodiment of the publication provides a wireless signal reinforcement method, and its flow is shown in FIG. 1. The method comprises the following steps: In step 101, a mobile wireless access point moves, and measures the wireless signal strength of other wireless access points while the mobile wireless access point moving.

Optionally, the other wireless access points disclosed in this step 101 are one or more specified wireless access points, or all wireless access points that enable the wireless terminal to access a specified network. In one embodiment, the mobile wireless access point uses WiFi to access the other wireless terminal. At this time, the access identifier is SSID. In other embodiments, other wireless communication means may be used, such as Bluetooth, ZigBee, etc., at this time, the access identifier may be other names.

Optionally, the mobile wireless access point disclosed in this step 101 may move along a pre-arranged route, or randomly, or according to a specific algorithm.

Optionally, the mobile wireless access point disclosed in step 101 includes a first wireless communication module and a second wireless communication module; the first wireless communication module is configured to provide access services to the wireless terminal, and the second wireless communication module is configured to access the mobile wireless access point to a specified communication network, the Internet or a specific local area network.

The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Step 102, determining a first location where the wireless signal needs to be reinforced according to the measurement result.

Step 103, the mobile wireless access point moving to the second location according to the first location, so that the strength of the wireless signal transmitted by the mobile wireless access point from the second location to the first location exceeding the strength of the wireless signal of other wireless access points at the first location.

Optionally, before “ the mobile wireless access point moving to the second location according to the first location ” in step 103, the following steps can also be comprised:

Setting the access identifier of the mobile wireless access point as the access identifier of one of the other wireless access points that need to be reinforced. For example, the access identifier may be updated as the access identifier of other wireless access points to be reinforced according to a control instruction or autonomously.

Optionally, before the step 103, the following steps \textcircled{1} and \textcircled{2} may also be included: step \textcircled{1}, determining whether the power of the mobile wireless access point meets the preset requirements; step \textcircled{2}, controlling the mobile wireless access point whose power does not meet the preset requirements to move to the charging pile for charging. It can be understood that steps \textcircled{1} and \textcircled{2} may be any time before step 103, including before step 101 and step 102.

In one embodiment, the mobile wireless access point may be a mobile wireless access point of the embodiment shown in FIG. 11.

Optionally, the wireless signal reinforcement method of this embodiment may be applied to the control system including indoor intelligent sweeper, education robot and accompanying robot for special people (such as children and the elderly), as well as smart home; It can also be applied to outdoor robots, handling robots, driverless vehicles, shuttle vehicles in specific areas (such as shopping malls and schools), driverless cleaning vehicles, driverless advertising vehicles, etc. The second embodiment of the publication provides a wireless signal reinforcement system, the structure of which is shown in FIG. 2. The wireless signal reinforcement system includes a mobile wireless access point, a measurement module, a determination module and a first control module.

The following is a Detailed Description:

The measurement module is configured to measure the wireless signal strength of other wireless access points received at each location in the path of the mobile wireless access point as it moves.

Optionally, the measurement module is configured in the mobile wireless access point.

Optionally, the wireless signal reinforcement system may also include a storage module for storing the wireless signal strength of other wireless access points received at the location through which the mobile wireless access point is measured by the measurement module. It can be understood that the storage module may be configured in an independent server connected to the same network as the mobile wireless access point, or may be configured in the mobile wireless access point.

Optionally, the other wireless access points are one or more specified wireless access points, or all wireless access points that enable the wireless terminal to access the specified network. In one embodiment, the mobile wireless access point uses WiFi to access the other wireless terminal. At this time, the access identifier is SSID. In other embodiments, other wireless communication methods may be used, such as Bluetooth, ZigBee, etc. at this time, the access identifier may be other names.

Optionally, the mobile wireless access point moves along a pre-arranged route, or randomly, or according to a specific algorithm.

Optionally, the mobile wireless access point includes a first wireless communication module and a second wireless communication module; The first wireless communication module is configured to provide access services to the wireless terminal, and the second wireless communication module is configured to access the mobile wireless access point to a specified communication network.

The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Further, the determination module is configured to determine a first location where the wireless signal needs to be reinforced according to the measurement result.

Further, the first control module is configured to control the mobile wireless access point to move to the second location according to the first location, so that the strength of the wireless signal transmitted by the mobile wireless access point from the second location to the first location exceeds the strength of the wireless signal of the other wireless access points at the first location.

Optionally, the first control module is also configured to determine whether the power of the mobile wireless access point meets the preset requirements, and control the mobile wireless access point whose power does not meet the preset requirements to move to the charging pile for charging. For example, the control module may determine whether the power of the mobile wireless access point meets the preset requirements in real time, or the control module may periodically determine whether the power of the mobile wireless access point meets the preset requirements, or the control module may irregularly determine whether the power of the mobile wireless access point meets the preset requirements, and so on.

Optionally, the wireless signal reinforcement system may also include a first setting module for setting the access identifier of the mobile wireless access point as the access identifier of one of the other wireless access points that need to be reinforced. For example, the first setting module can update the access identifier as the access identifier of other wireless access points to be reinforced according to a control instruction of the first control module or autonomously.

In this embodiment, the determination module and the first control module are configured in an independent server connected to the same network as the mobile wireless access point, or may be configured in the mobile wireless access point.

The first embodiment is a method embodiment corresponding to this embodiment. The technical details in the first embodiment can be applied to this embodiment, and the technical details in this embodiment can also be applied to the first embodiment.

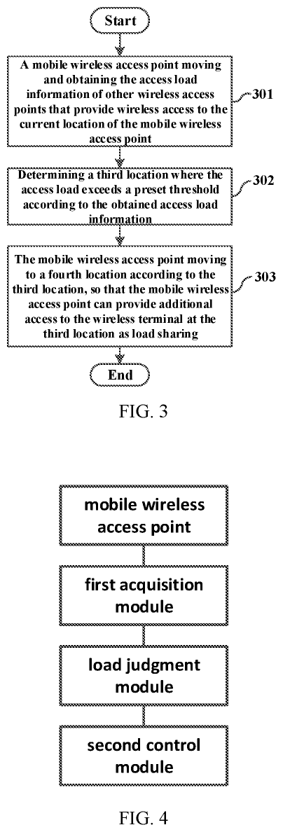

The third embodiment of the publication relates to a wireless network load sharing method, the flow of which is shown in FIG. 3. The method comprises the following steps: Step 301, a mobile wireless access point moving and obtaining the access load information of other wireless access points that provide wireless access to the current location of the mobile wireless access point.

Optionally, the other wireless access points are one or more specified wireless access points, or all wireless access points that enable the wireless terminal to access the specified network. In one embodiment, the mobile wireless access point uses WiFi to access other wireless terminals, and the access identifier is SSID. In other embodiments, other wireless communication methods may be used, such as Bluetooth, ZigBee, etc. at this time, the access identifier may be other names.

Optionally, the mobile wireless access point moves along a pre-arranged route, or randomly, or according to a specific algorithm.

Optionally, the mobile wireless access point includes a first wireless communication module and a second wireless communication module; The first wireless communication module is configured to provide access services to the wireless terminal, and the second wireless communication module is configured to access the mobile wireless access point to a specified communication network.

The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Step 302, determining a third location where the access load exceeds a preset threshold according to the obtained access load information.

Step 303, the mobile wireless access point moving to a fourth location according to the third location, so that the mobile wireless access point can provide additional access to the wireless terminal at the third location as load sharing.

Optionally, before “ the mobile wireless access point moving to a fourth location according to the third location ” in step 303, the following steps may also be included: Setting the access identifier of the mobile wireless access point as the access identifier of one of the other wireless access points that provides other access to the wireless terminal at the third location. For example, there was originally a wireless access point X at the third location, but the load of the wireless access point Xis too heavy. When the mobile wireless access point is moved to the fourth location, the SSID of the mobile wireless access point may be changed to the same SSID as X.

Optionally, before the step 103, the following steps \textcircled{1} and \textcircled{2} may also be included: step \textcircled{1}, determining whether the power of the mobile wireless access point meets the preset requirements; step \textcircled{2}, controlling the mobile wireless access point whose power does not meet the preset requirements to move to the charging pile for charging. It can be understood that steps \textcircled{1} and \textcircled{2} may be any time before step 103, including before step 101 and step 102.

In one embodiment, the mobile wireless access point may be a mobile wireless access point of the embodiment shown in FIG. 11.

Optionally, the wireless network load sharing method of the embodiment of the present publication may be applied to the control system including indoor intelligent sweeper, education robot and accompanying robot for special people (such as children and the elderly), as well as smart home; It can also be applied to outdoor robots, handling robots, driverless vehicles, shuttle vehicles in specific areas (such as shopping malls and schools), driverless cleaning vehicles, driverless advertising vehicles, etc.

The fourth embodiment of the publication relates to a wireless network load sharing system, the structure of which is shown in FIG. 4. The wireless network load sharing system includes a mobile wireless access point, a first acquisition module, a load judgment module and a second control module.

The following is a Detailed Description:

The first acquisition module is configured to acquire the access load information of other wireless access points that provide wireless access to the current location of the mobile wireless access point while the mobile wireless access point moving. Optionally, the first acquisition module may be configured in a mobile wireless access point. Optionally, some functions of the first acquisition module can also be configured in an independent server connected to the same network side as the mobile wireless access point.

Optionally, the other wireless access points are one or more specified wireless access points, or all wireless access points that enable the wireless terminal to access the specified network. In one embodiment, the mobile wireless access point uses WiFi to access other wireless terminals. At this time, the access identifier is SSID. In other embodiments, other wireless communication methods may be used, such as Bluetooth, ZigBee, etc., at this time, the access identifier may be other names. Optionally, the mobile wireless access point moves along a pre-arranged route, or randomly, or according to a specific algorithm.

Optionally, the mobile wireless access point includes a first wireless communication module and a second wireless communication module; The first wireless communication module is configured to provide access services to the wireless terminal, and the second wireless communication module is configured to access the mobile wireless access point to a specified communication network. The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Further, the load judgment module is configured to determine a third location where the access load exceeds a preset threshold according to the obtained access load information.

Further, the second control module is configured to control the mobile wireless access point to move to the fourth location according to the third location, so that the mobile wireless access point can provide additional access to the wireless terminal at the third location, so as to share the load. Optionally, the wireless network load sharing system may also include a second setting module for setting the access identifier of the mobile wireless access point as the access identifier of the wireless access point that provides other access to the wireless terminal at the third location.

Optionally, the second control module is also configured to determine whether the power of the mobile wireless access point meets the preset requirements, and control the mobile wireless access point whose power does not meet the preset requirements to move to the charging pile for charging. In this embodiment, the load judgment module and the second control module may be configured in an independent server connected to the same network as the mobile wireless access point, or may be configured in the mobile wireless access point.

The third embodiment is a method embodiment corresponding to this embodiment. The technical details in the third embodiment may be applied to this embodiment, and the technical details in this embodiment can also be applied to the third embodiment.

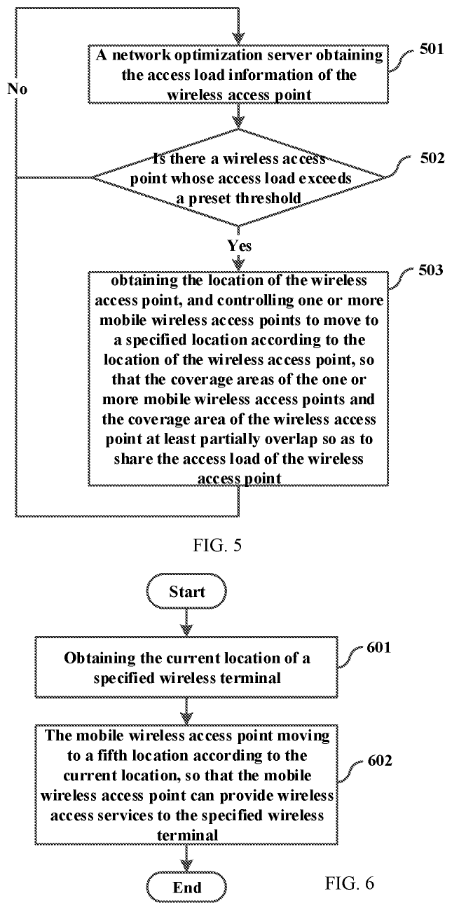

The fifth embodiment of the present publication provides a wireless network load sharing method, as shown in the flowchart in FIG. 5. The method comprises:

Step 501, the network optimization module obtains the access load information of each wireless access point.

Optionally, the network optimization module may be configured in an independent server connected to each wireless access point, or in a mobile wireless access point, or in a plurality of mobile wireless access points.

Optionally, the wireless access point is one or more specified wireless access points, or all wireless access points that enable the wireless terminal to access the specified network.

Then, go to step 502, determining whether the access load of any wireless access point exceeds a preset threshold? If yes, go to step 503, obtaining the location of the wireless access point, and specifying one or more mobile wireless access points to move near the wireless access point according to the location, so that the coverage of the mobile wireless access point and the coverage area of the wireless access point at least partially overlap, so as to share the access load for the wireless access point, and then return to step 501. Otherwise, return directly to step 501.

Optionally, the network optimization module can select one or more mobile wireless access points according to the overall network environment of the wireless network and send them to move near the wireless access point. For example, the network optimization module may integrate(such as statistics, corrections and weighted averages etc.) the wireless signal strength data of other wireless access points reported by different mobile wireless access points to obtain the wireless signal coverage map of wireless access points in the overall network service area, Then, according to the wireless signal coverage map, the mobile wireless access point stopping in the area with relatively strong wireless signal is specified to move near the wireless access point to share the access load for the wireless access point.

The wireless access point may be of various types. Optionally, the wireless access point may be a fixed wireless access point, and the location of the fixed wireless access point is pre-configured in the network optimization module to realize that the network optimization module can obtain its location from its own configuration at any time. Optionally, the wireless access point may include both a fixed wireless access point and a mobile wireless access point. For the mobile wireless access point, the current location may be reported to the network optimization module through the periodic report (including real-time report) of the mobile wireless access point or after movement, so that the network optimization module can obtain the current location of the mobile wireless access point. Optionally, before “specifying one or more mobile wireless access points to move near the wireless access point according to the location” in step 502, the following steps are also included:

The access identifier of the mobile wireless access point is set as the access identifier of the wireless access point that provides other access to the wireless terminal at the overlapped area.

In one embodiment, the mobile wireless access point uses WiFi to access other wireless terminals. At this time, the access identifier is SSID. In other embodiments, other wireless communication methods may be used, such as Bluetooth, ZigBee, etc., at this time, the access identifier may be other names.

In one embodiment, the mobile wireless access point may be a mobile wireless access point of the embodiment shown in FIG. 11.

Accordingly, the sixth embodiment of the publication also provides a wireless network load sharing system, which includes a wireless access point and a network optimization module, wherein the wireless access point includes a fixed wireless access point and at least one mobile wireless access point; The network optimization module is configured to obtain the access load information of each wireless access point, and if there is a wireless access point whose access load exceeds the preset threshold, obtain the location of the wireless access point, and specify one or more mobile wireless access points to move near the wireless access point according to the location, so that the coverage of the mobile wireless access point and the coverage area of the wireless access point at least partially overlap. Thus, it plays the role of sharing the access load for the wireless access point. Optionally, the wireless access point is one or more specified wireless access points, or all wireless access points that enable the wireless terminal to access the specified network.

Optionally, the network optimization module is also configured to pre-configure the location of the fixed wireless access point so that the network optimization module can obtain its location from its own configuration at any time.

Optionally, the mobile wireless access point is configured to report periodically (including real-time reporting) or report the current location to the network optimization module after the movement, so that the network optimization module can obtain the real-time location of the mobile wireless access point in real time.

Optionally, the network optimization module is also configured to set the access identifier of the specified mobile wireless access point as the access identifier of the wireless access point that provides other access to the wireless terminal at the overlapped area.

In one embodiment, the mobile wireless access point uses WiFi to access other wireless terminals. At this time, the access identifier is SSID. In other embodiments, other wireless communication methods may be used, such as Bluetooth, ZigBee, etc., at this time, the access identifier may be other names.

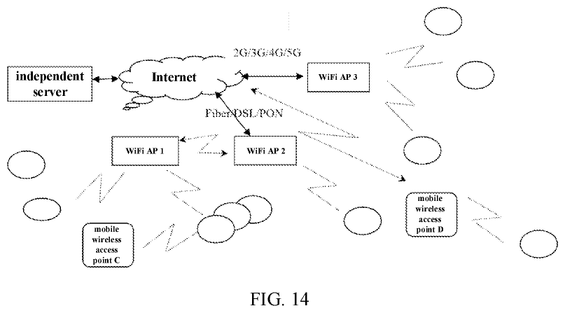

Optionally, for example, as shown in FIG. 13, the network optimization module is configured in one or more mobile wireless access points, or, for example, as shown in FIG. 14, the network optimization module is configured in an independent server connected to each wireless access point. The fifth embodiment is a method embodiment corresponding to this embodiment. The technical details in the fifth embodiment may be applied to this embodiment, and the technical details in this embodiment can also be applied to the fifth embodiment.

The seventh embodiment of the publication relates to a method for wireless network following service. Its flow is shown in FIG. 6. The method comprises the following steps:

In step 601, the current location of the specified wireless terminal is obtained.

Optionally, the specified wireless terminal may be a wireless terminal with priority higher than a preset threshold.

There may be various ways to obtain the current location of the specified wireless terminal. Optionally, periodically obtain the current location of the specified wireless terminal. Optionally, the specified wireless terminal reports the new current location when the location changes. The tracking of the specified wireless terminal may be realized by these means.

Optionally, the step 601 may further include the following steps: first, discover and lock a specified wireless terminal using optical detection technology; Then, the current location of the specified wireless terminal is obtained.

Optionally, the mobile wireless access point includes a first wireless communication module and a second wireless communication module; The first wireless communication module is configured to provide access services to the wireless terminal, and the second wireless communication module is configured to access the mobile wireless access point to a specified communication network.

The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Then, go to step 602, controlling the mobile wireless access point to move to a fifth location according to the current location, so that the mobile wireless access point can provide wireless access services to the specified wireless terminal at the current location.

Optionally, the step 602 may also include the following steps: making the mobile wireless access point an intelligent follow-up wireless access point of the specified wireless terminal through local setting or remote setting. This can provide mobile terminals or portable products with the lowest cost and the most efficient way, and enjoy ubiquitous high-quality wireless access services.

Optionally, before “controlling the mobile wireless access point to move to a fifth location according to the current location” in step 602, it may also include:

Setting the access identifier of the mobile wireless access point as the access identifier of the wireless access point that provides other access to the specified wireless terminal at the current location.

Optionally, before the step 103, the following steps \textcircled{1} and \textcircled{2} may also be included: step \textcircled{1}, determining whether the power of the mobile wireless access point meets the preset requirements; step \textcircled{2}, controlling the mobile wireless access point whose power does not meet the preset requirements to move to the charging pile for charging. It can be understood that steps \textcircled{1} and \textcircled{2} may be any time before step 103, including before step 101 and step 102.

In one embodiment, the mobile wireless access point may be a mobile wireless access point of the embodiment shown in FIG. 11.

Optionally, the method for wireless network following service according to the embodiment of the publication may be applied to the control system including indoor intelligent sweeper, education robot and accompanying robot for special people (such as children and the elderly), as well as smart home; It can also be applied to outdoor robots, handling robots, driverless vehicles, shuttle vehicles in specific areas (such as shopping malls and schools), driverless cleaning vehicles, driverless advertising vehicles, etc.

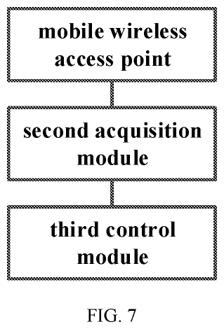

Accordingly, the eighth embodiment of the present publication relates to a system for wireless network following service, the structure of which is shown in FIG. 7. The system for wireless network following service includes a mobile wireless access point, a second acquisition module and a third control module.

The following is a detailed description:

The second acquisition module is configured to obtain the current location of the specified wireless terminal. Preferably, the second acquisition module is configured in a mobile wireless access point. Optionally, some functions of the second acquisition module can also be configured in an independent server connected to the same network side as the mobile wireless access point.

Optionally, the specified wireless terminal may be a wireless terminal with priority higher than the preset threshold.

The second acquisition module may acquire the current location of the specified wireless terminal in various ways. Optionally, the second acquisition module may periodically acquire the current location of the specified wireless terminal. Optionally, the specified wireless terminal reports the new current location when the location changes. The tracking of the specified wireless terminal may be realized by these means.

Optionally, the second acquisition module can use optical detection technology to discover and lock the specified wireless terminal, and then obtain the current location of the specified wireless terminal.

Further, the third control module is configured to control the mobile wireless access point to move to the fifth location according to the current location, so that the mobile wireless access point can provide wireless access services to the specified wireless terminal at the current location.

Optionally, the third control module is also configured to make the mobile wireless access point an intelligent follow-up wireless access point of the specified wireless terminal through setting or remote setting. This can provide mobile terminals or portable products with the lowest cost and the most efficient way, and enjoy ubiquitous high-quality wireless access services. Optionally, the mobile wireless access point includes a first wireless communication module and a second wireless communication module; The first wireless communication module is configured to provide access services to the wireless terminal, and the second wireless communication module is configured to access the mobile wireless access point to a specified communication network.

The types of the first wireless communication module and the second communication module are various. In one embodiment, the first wireless communication module may be a WiFi module, etc., and the second wireless communication module may be a mobile communication network module or a WiFi module, etc., wherein the mobile communication network may be a communication network such as 3G, 4G and 5G, or other communication networks to be developed. In other embodiments, the first wireless communication module and the second wireless communication module may be any other wireless communication module.

Optionally, the wireless network load sharing system may also include a third setting module for setting the access identifier of the mobile wireless access point as the access identifier of the wireless access point that provides other access to the specified wireless terminal at the third location.

Optionally, the third control module is also configured to determine whether the power of the mobile wireless access point meets the preset requirements, and control the mobile wireless access point whose power does not meet the preset requirements to move to the charging pile for charging. In this embodiment, the third control module may be configured in an independent server connected to the same network as the mobile wireless access point, or in the mobile wireless access point.

The seventh embodiment is a method embodiment corresponding to this embodiment. The technical details in the seventh embodiment may be applied to this embodiment, and the technical details in this embodiment can also be applied to the seventh embodiment.

The ninth embodiment of the publication relates to a method for wireless network service, which includes: wireless network enhancement according to the first embodiment of the publication, and/or wireless network load sharing according to the third embodiment of the publication, and/or wireless network load sharing according to the fifth embodiment of the publication, and/or wireless network follow-up service according to the seventh embodiment of the publication. Wherein, the first embodiment, the third embodiment, the fifth embodiment and the seventh embodiment are all subsets of this embodiment. The method for wireless network service of this embodiment may be any two, three or four combinations of the four, and the execution order may be set arbitrarily according to specific situations.

In one embodiment, the mobile wireless access point may be a mobile wireless access point of the embodiment shown in FIG. 11.

Optionally, the method for wireless network service according to the embodiment of the present publication may be applied to a control system including an indoor intelligent floor sweeper, an education robot, an accompanying robot for special people (such as children and the elderly), and a smart home; It can also be applied to outdoor robots, handling robots, driverless vehicles, shuttle vehicles in specific areas (such as shopping malls and schools), driverless cleaning vehicles, driverless advertising vehicles, etc.

In order to better understand the ninth embodiment, the following will be described in combination with a specific example A and example B. The details listed in example A and example B are mainly for ease of understanding and do not serve as a limitation on the scope of protection of the present publication.

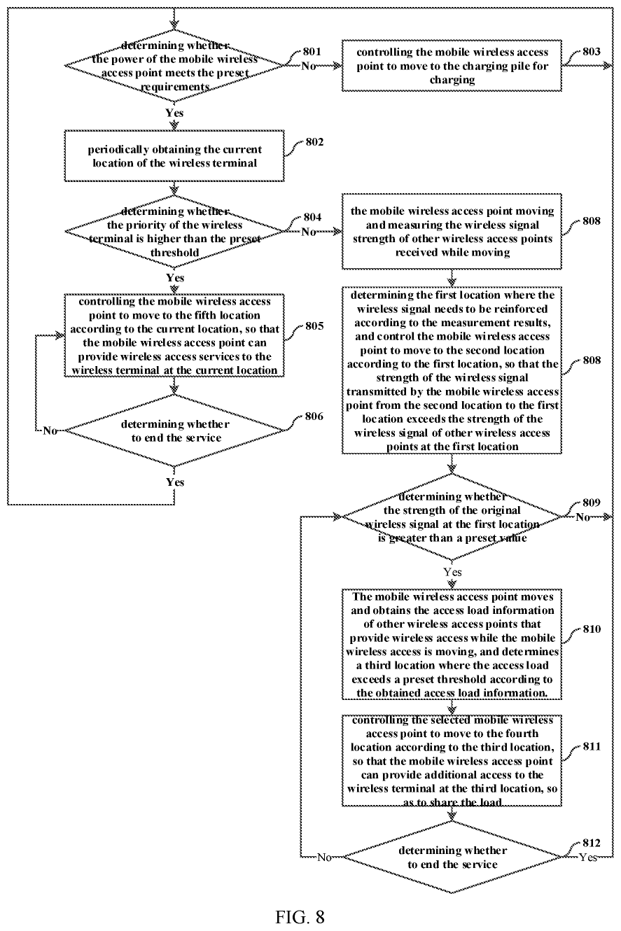

As shown in FIG. 8, example A is a wireless network service process based on a mobile wireless access point, which includes the following steps:

In step 801, determine whether the power of the mobile wireless access point meets the preset requirements? If yes, go to step 802 to periodically obtain the current location of the wireless terminal. Otherwise, go to step 803 to control the mobile wireless access point to move to the charging pile for charging.

After step 802, go to step 804 to determine whether the priority of the wireless terminal is higher than the preset threshold? If yes, go to step 805 to control the mobile wireless access point to move to the fifth location according to the current location, so that the mobile wireless access point can provide wireless access services to the wireless terminal at the current location. Otherwise, go to step 808, the mobile wireless access point moving and measuring the wireless signal strength of other wireless access points received while moving.

After step 805, go to step 806 to determine whether to end the service? If yes, go to step 801. Otherwise, return to step 805.

After step 808, go to step 809 to determine the first location where the wireless signal needs to be reinforced according to the measurement results, and control the mobile wireless access point to move to the second location according to the first location, so that the strength of the wireless signal transmitted by the mobile wireless access point from the second location to the first location exceeds the strength of the wireless signal of other wireless access points at the first location. After step 809, go to step 810 to determine whether the strength of the original wireless signal at the first location is greater than a preset value? If yes, go to step 810. The mobile wireless access point moves and obtains the access load information of other wireless access points that provide wireless access while the mobile wireless access is moving, and determines a third location where the access load exceeds a preset threshold according to the obtained access load information. Otherwise, return to step 801.

After step 810, go to step 811 to control the selected mobile wireless access point to move to the fourth location according to the third location, so that the mobile wireless access point can provide additional access to the wireless terminal at the third location, so as to share the load. After step 811, go to step 812 to determine whether to end the service? If yes, go to step 801. Otherwise, return to step 809.

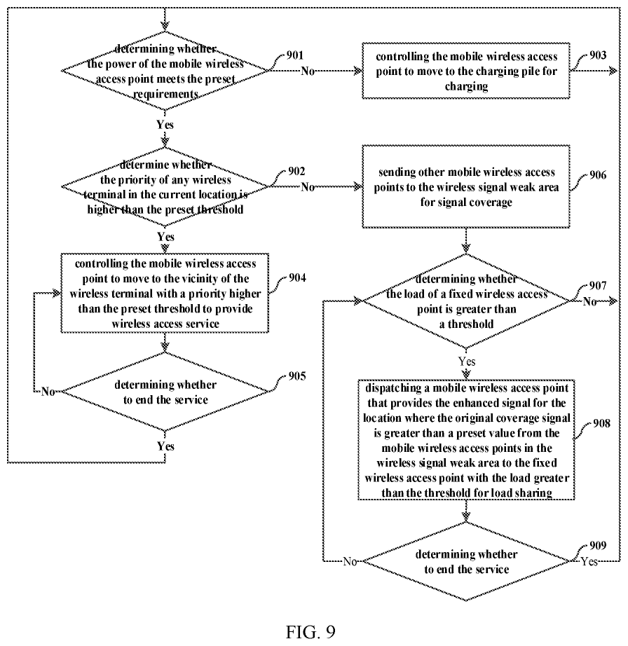

As shown in FIG. 9, the example B is a wireless network service process based on multiple mobile wireless access points, specifically including the following steps:

In step 901, determining whether the power of the mobile wireless access point meets the preset requirements? If yes, go to step 902, continue to determine whether the priority of any wireless terminal in the current location is higher than the preset threshold? Otherwise, go to step 903, controlling the mobile wireless access point to move to the charging pile for charging, and return to step 901 after step 903. If the result of step 902 is yes, go to step 904, controlling the mobile wireless access point to move to the vicinity of the wireless terminal with a priority higher than the preset threshold according to the current location to provide wireless access service. Otherwise, go to step 906, sending other mobile wireless access points to the wireless signal weak area for signal coverage.

After step 904, go to step 905, determining whether to end the service? If yes, return to step 901. Otherwise, return to step 904. After step 906, go to step 907, determining whether the load of a fixed wireless access point is greater than a threshold. If yes, go to step 908, dispatching a mobile wireless access point that provides the enhanced signal for the location where the original coverage signal is greater than a preset value from the mobile wireless access points in the wireless signal weak area to the fixed wireless access point with the load greater than the threshold for load sharing. If yes, go to step 908, from the mobile wireless access points in the wireless signal weak area, dispatching a mobile wireless access point which provides the enhanced signal for the location where the original coverage signal is greater than a preset value to the fixed wireless access point for load sharing. Otherwise, return to step 901.

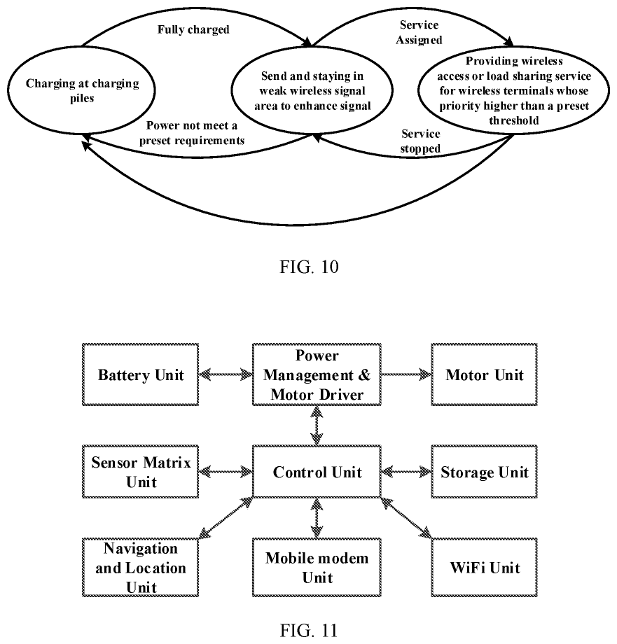

After step 908, go to step 909, determining whether to end the service? If yes, return to step 901. Otherwise, return to step 907. Further, the state switching of the example B may be as shown in FIG. 10.

Accordingly, the tenth embodiment of the present publication provides a wireless network service system. The ninth embodiment is a method embodiment corresponding to this embodiment. The technical details in the ninth embodiment may be applied to this embodiment, and the technical details in this embodiment can also be applied to the ninth embodiment.

In order to better understand the technical solution of the publication, the following will be explained in combination with an embodiment of a mobile wireless access point. The details listed in the mobile wireless access point of the embodiment are mainly for ease of understanding and are not used as a limitation on the scope of protection of the publication.

As shown in FIG. 11, the mobile wireless access point of this embodiment includes a battery unit, a Power Management & Motor Driver, a Motor Unit, a Sensor Matrix Unit, a storage unit, a Navigation and Location Unit, a Mobile modem Unit , a WiFi Unit and a Control Unit.

Wherein, the Sensor Matrix Unit is connected with various sensors. For example, the sensors may include radio detector (Radar), laser locator (Lidar), image sensor (such as camera sensor, ToF, structure light, etc.), infrared sensor (IR), ultrasonic sensor, mic-phone, gyroscope, etc. On the one hand, these sensors actively detect the surrounding environment of the mobile wireless access point of the embodiment and provide effective information, such as providing reference data for Navigation and Location Unit; On the other hand, these sensors collect the instructions form people (wireless terminal) and detect the state of people (such as face recognition, emotion recognition and gesture recognition), and do object recognition, and even anti-counterfeiting recognition, so as to interact with the mobile wireless access point of the embodiment, or enable the mobile wireless access point to lock on a following target. In addition, the Sensor Matrix Unit also properly processes and fuses the sensor signals, and finally transmits the relevant signal information to the Control Unit.

The Navigation and Location Unit includes a navigation engine, a map engine and a locating function. On the one hand, the navigation engine receives the navigation reference data sent by the Sensor Matrix Unit from the Control Unit, and on the other hand, the mobile destination instruction sent from the independent server (or the network optimization module of the mobile wireless access point of the embodiment), the navigation engine generates the navigation path planning according to the input parameters and self-built algorithm, combined with the map information. In addition to maintaining the map data, the map engine also receives the reference data of navigation, and updates the map data irregularly through its own filter and algorithm.

Mobile modem Unit is a mobile communication module, including 2G/3G/4G/5G and other systems. It is the communication technology between autonomous mobile devices and Internet access. However, Mobile modem Unit is not a necessary part. The Internet may be accessed through WiFi Unit. It can be understood that the Mobile modem Unit corresponds to the second communication module disclosed in the present publication.

The WiFi Unit has two modes, one is AP mode, which act as an access point to provide other devices with access to a network; The other is STA mode, which connects the access network data of the mobile wireless access point of the embodiment to another WiFi access point, which usually is an access point with broadband communication technology (such as xDSL, cable, FTTH, PON, etc.). The above two modes may work at the same time or only AP mode. However, if there is only AP mode, the Mobile modem Unit must exist. In addition to the above general WiFi AP functions, it is also necessary to support measuring and recording the signal strength of other WiFi access points, and regularly update it to an independent server (or the network optimization module of the mobile wireless access point of the embodiment) to reinforce the WiFi access points with weak signals. The SSID needs to be updated before reinforcing the WiFi access point with weak signal, wherein the SSID can be updated according to an instruction of an independent server(or the network optimization module of the mobile wireless access point of the embodiment), or automatically updated to the same SSID as the WiFi hotspot to be reinforced. It can be understood that the WiFi Unit in AP mode corresponds to the first communication module disclosed in the publication, and the WiFi Unit in STA mode corresponds to the second communication module disclosed in the publication.

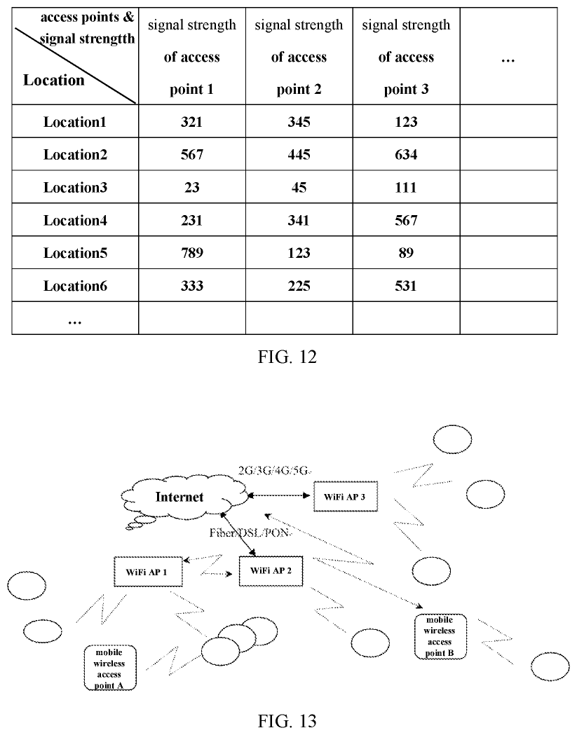

The Control Unit is the general processing unit of the mobile wireless access point of the embodiment. On the one hand, the Control Unit receives the environment information and navigation reference data from the Sensor Matrix and forwards them to the Navigation and Location Unit; On the other hand, the Control Unit sends instructions to the Motor Driver in the Power Management & Motor Driver to control the travel direction and speed of the Motor Unit according to the navigation direction and travel distance of the mobile wireless access point of the embodiment determined by the Navigation and Location Unit, and sends instructions to the Power Management in the Power Management & Motor Driver to effectively charge the battery; And further, the Control Unit, as a data router, appropriately routes the data received from the WiFi Unit to the Mobile modem or other WiFi access points, sends the data obtained from the network to the STA through the WiFi Unit, and integrates the signal strength information of other WiFi access points received from the WiFi Unit with the locating and map information of the Navigation and Location Unit into a table format, such as the table format shown in FIG. 12, And regularly sends this table to an independent server (or the network optimization module of the mobile wireless access point of the embodiment).

The Motor Unit includes a motor and an electromechanical system, which is the power part of the mobile wireless access point mainly responsible for this embodiment. The moving direction, speed and distance of the mobile wireless access point of this embodiment may be realized by controlling Motor Unit through motor drive. Wherein, the moving direction, speed and distance of the mobile wireless access point of the embodiment may be determined according to the locating and navigation functions of the Control Unit.

As shown in FIG. 13, it is the network architecture diagram of the mobile wireless access point (with network optimization module) of the embodiment.

As shown in FIG. 14, it is a network architecture diagram of a mobile wireless access point (without a network optimization module) and an independent server of the embodiment.

Those skilled in the art should understand that the implementation functions of each module shown in the embodiments of the wireless signal reinforcement system, the wireless network load sharing system, the system for wireless network following service and the wireless network service system, can be understood by referring to the relevant description of the wireless signal reinforcement method, the wireless network load sharing method, the method for wireless network following service and the method for wireless network service. The functions of each module shown in the embodiments of the wireless signal reinforcement system, the wireless network load sharing system, the system for wireless network following service and the wireless network service system may be realized by a program (executable instruction) running on the processor or by a specific logic circuit. The wireless signal reinforcement system, the wireless network load sharing system, the system for wireless network following service and the wireless network service system in the embodiment of the publication can also be stored in a computer-readable storage medium if they are implemented in the form of software function modules and sold or used as independent products. Based on this understanding, the technical solution of the embodiment of the publication, in essence or the part that contributes to the prior art, may be embodied in the form of a software product, which is stored in a storage medium and includes several instructions to enable a computer device (which may be a personal computer, server, network device, etc.) to perform all or part of the methods described in each embodiment of the publication. The aforementioned storage media include: USB flash disk, mobile hard disk, read only memory (ROM), magnetic disc or optical disc and other media that can store program code. Thus, the embodiments of the present publication are not limited to any specific combination of hardware and software.

Accordingly, the embodiment of the publication also provides a computer-readable storage medium, in which computer executable instructions are stored. When the computer executable instructions are executed by the processor, the method embodiments of the publication are realized. Computer readable storage media include permanent and non-permanent, removable and non-removable media, and information storage may be realized by any method or technology. The information may be computer-readable instructions, data structures, modules of programs, or other data. Examples of storage media of a computer include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, read only optical disc read only memory (CD-ROM), digital versatile disc (DVD) or other optical storage Magnetic tape cartridge, magnetic tape, magnetic disk storage or other magnetic storage device or any other non-transmission medium may be configured to store information that may be accessed by computing devices.

In addition, the embodiment of the publication also provides a wireless signal reinforcement system, which includes a memory for storing computer executable instructions and a processor; The processor is configured to realize the steps in each embodiment of the wireless signal reinforcement method of the first embodiment when executing the computer executable instructions in the memory. Among them, the processor may be a central processing unit (CPU), other general-purpose processors, digital signal processors (DSP), publication specific integrated circuits (ASIC), etc. The aforementioned memory may be read-only memory (ROM), random access memory (RAM), flash memory (flash), hard disk or solid-state disk. The steps of the method disclosed in each embodiment of the invention may be directly reflected in the execution of the hardware processor, or the combination of hardware and software modules in the processor.

The embodiment of the publication also provides a wireless network load sharing system, which includes a memory for storing computer executable instructions and a processor; The processor is configured to realize the steps in each embodiment of the wireless network load sharing method of the third embodiment when executing the computer executable instructions in the memory. Among them, the processor may be a central processing unit (CPU), other general-purpose processors, digital signal processors (DSP), publication specific integrated circuits (ASIC), etc. The aforementioned memory may be read-only memory (ROM), random access memory (RAM), flash memory (flash), hard disk or solid-state disk. The steps of the method disclosed in each embodiment of the invention may be directly reflected in the execution of the hardware processor, or the combination of hardware and software modules in the processor.

The embodiment of the publication also provides a wireless network load sharing system, which includes a memory for storing computer executable instructions and a processor; The processor is configured to realize the steps in each embodiment of the wireless network load sharing method of the fifth embodiment when executing the computer executable instructions in the memory. Among them, the processor may be a central processing unit (CPU), other general-purpose processors, digital signal processors (DSP), publication specific integrated circuits (ASIC), etc. The aforementioned memory may be read-only memory (ROM), random access memory (RAM), flash memory (flash), hard disk or solid-state disk. The steps of the method disclosed in each embodiment of the invention may be directly reflected in the execution of the hardware processor, or the combination of hardware and software modules in the processor.

The embodiment of the publication also provides a system for wireless network following service, which includes a memory for storing computer executable instructions and a processor; The processor is configured to realize the steps in each embodiment of the wireless network load sharing method of the seventh embodiment when executing the computer executable instructions in the memory. Among them, the processor may be a central processing unit (CPU), other general-purpose processors, digital signal processors (DSP), publication specific integrated circuits (ASIC), etc. The aforementioned memory may be read-only memory (ROM), random access memory (RAM), flash memory (flash), hard disk or solid-state disk. The steps of the method disclosed in each embodiment of the invention may be directly reflected in the execution of the hardware processor, or the combination of hardware and software modules in the processor.

The embodiment of the publication also provides a wireless network service system, which includes a memory for storing computer executable instructions and a processor; The processor is configured to implement the steps in each embodiment of the method for wireless network service of the ninth embodiment when executing the computer executable instructions in the memory. Among them, the processor may be a central processing unit (CPU), other general-purpose processors, digital signal processors (DSP), publication specific integrated circuits (ASIC), etc. The aforementioned memory may be read-only memory (ROM), random access memory (RAM), flash memory (flash), hard disk or solid-state disk. The steps of the method disclosed in each embodiment of the invention may be directly reflected in the execution of the hardware processor, or the combination of hardware and software modules in the processor.

It should be noted that in the specification, relational terms such as first and second are only configured to distinguish one entity or operation from another entity or operation, and do not necessarily require or imply any such actual relationship or order between these entities or operations. Moreover, the terms “comprise”, “include” or any other variation thereof are intended to cover non-exclusive inclusion, so that a process, a method, an article or an equipment including a set of elements may include not only those elements, but also other elements not explicitly listed, or elements inherent in such process, method, article or equipment. Without further restriction, the element defined by the statement “comprising a” does not exclude the existence of another same element in the process, method, article or equipment including the element. In the specification, if it is mentioned to perform an operation according to an element, it means to perform the operation at least according to the element, which includes two situations: performing the operation only according to the element, and performing the operation according to the element and other elements. The expressions of multiple, a plurality of means 2 or more than 2.

All documents mentioned in the specification are considered to be included in the publication as a whole, so that they may be used as the basis for amendment if necessary. In addition, it shall be understood that the foregoing are merely better examples of the specification and are not intended to limit the scope of protection of the specification. Any modification, equivalent replacement, improvement, etc. within the spirit and principles of one or more embodiments of this specification shall be included in the scope of protection of such one or more embodiments of this specification.

1-25. (canceled)

26. A method for wireless network service, comprising:
Obtaining the current location of a specified wireless terminal; and
The mobile wireless access point moving to a fifth location according to the current location, so that the mobile wireless access point can provide wireless access services to the specified wireless terminal;
Wherein, the mobile wireless access point moving with the specified wireless terminal while the specified wireless terminal moving.

27. The method of claim 26, wherein before obtaining the current location of a specified wireless terminal, the method further comprising:
Determining the priority of the specified wireless terminal is higher than a preset threshold.

28. The method of claim 27, wherein the method further comprising:
Determining the priority of the specified wireless terminal is not higher than the preset threshold;
Measuring, by a mobile wireless access point, the wireless signal strength of other wireless access points while the mobile wireless access point moving;
Determining a first location where the wireless signal needs to be reinforced according to the measurement result; and
The mobile wireless access point moving to the second location according to the first location, so that the strength of the wireless signal transmitted by the mobile wireless access point from the second location to the first location exceeding the strength of the wireless signal of other wireless access points at the first location.

29. The method of claim 28, wherein before the mobile wireless access point moving to the second location according to the first location, the method further comprising:
Setting the access identifier of the mobile wireless access point as the access identifier of one of the other wireless access points that need to be reinforced.

30. The method of claim 28, wherein the other wireless access points are one or more specified wireless access points, or all wireless access points that can enable the wireless terminal to access the specified network.

31. The method of claim 28, wherein the mobile wireless access point moving along a pre-arranged route or moving randomly.

32. The method of claim 28, wherein before the step of the mobile wireless access point moving, the method further comprising:
Determining whether the power of the mobile wireless access point meets the preset requirements;
The mobile wireless access point whose power does not meet the preset requirements moving to the charging pile for charging.

33. The method of claim 27, wherein the method further comprising:
Determining the priority of the specified wireless terminal is not higher than the preset threshold;
A mobile wireless access point moving and obtaining the access load information of other wireless access points that provide wireless access to the current location of the mobile wireless access point;
Determining a third location where the access load exceeds a preset threshold according to the obtained access load information; and
The mobile wireless access point moving to a fourth location according to the third location, so that the mobile wireless access point can provide additional access to the wireless terminal at the third location as load sharing.

34. The method of claim 33, wherein before the mobile wireless access point moving to a fourth location according to the third location, the method further comprising:
Setting the access identifier of the mobile wireless access point as the access identifier of one of the other wireless access points that provides other access to the wireless terminal at the third location.

35. The method of claim 33, wherein the other wireless access points are one or more specified wireless access points, or all wireless access points that enable the wireless terminal to access the specified network.

36. The method of claim 33, wherein the mobile wireless access point moving along a pre-arranged route or moving randomly.

37. The method of claim 26, wherein the mobile wireless access point comprises a first wireless communication module and a second wireless communication module;
Wherein the first wireless communication module is configured to provide access services to wireless terminals, and the second wireless communication module is configured to access the mobile wireless access point to a specified communication network;
The first wireless communication module is a WiFi module, and the second wireless communication module is a mobile communication network module or a WiFi module.

38. A device, wherein, comprising:
A memory for storing computer executable instructions;
A processor for realizing the steps in the method according to claim 26 when executing the computer executable instruction.

39. A computer-readable storage medium in which computer executable instructions are stored, and the computer executable instructions are implemented when executed by a processor: the steps in the method according to claim 26 when executing the computer executable instruction.
